(19) United States
(12) Patent Application Publication
(10) Pub. No.: US 2025/0015857 A1
(43) Pub. Date: Jan. 9, 2025

(54) CROSS PUCCH GROUP CSI REPORTING

(71) Applicant: APPLE INC., Cupertino, CA (US)

(72) Inventors: Haitong Sun, Cupetino, CA (US); Amir Aminzadeh Gohari, Sunnyvale, CA (US); Dawei Zhang, Saratoga, CA (US); Haijing Hu, Los Gatos, CA (US); Jie Cui, San Jose, CA (US); Naveen Kumar R Palle Venkata, San Diego, CA (US); Wei Zeng, Saratoga, CA (US); Yushu Zhang, Beijing (CN)

(21) Appl. No.: 18/706,512

(22) PCT Filed: Nov. 5, 2021
(86) PCT No.: PCT/CN2021/129108

§ 371 Date: May 1, 2024

(51) Int. Cl. H04B 7/06; H04W 24/10; H04W 72/21

(52) U.S. Cl. CPC H04B 7/0626; H04W 24/10; H04W 72/21

(57) ABSTRACT

A user equipment (UE) performs capability exchange for indicating support of cross physical uplink control channel (PUCCH) group channel state information (CSI) reporting. In some embodiments, the UE receives a request from a network for the UE capability exchange and reports to the network whether cross PUCCH group CSI reporting is supported. The UE may also indicate whether a processing timeline for CSI reporting is to be relaxed to accommodate the cross PUCCH group CSI measurement and reporting.

### TECHNICAL FIELD

This application relates generally to wireless communication systems, including capability exchange for indicating support of cross physical uplink control channel (PUCCH) group channel state information (CSI) reporting.

### BACKGROUND INFORMATION

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

A UE may connect to either one or both of a 5G NR RAT and LTE RAT. The UE may support standalone carrier aggregation (CA) on LTE, CA on NR (NR-CA), or a variety of dual-connectivity (DC) functionalities in which a plurality of component carriers (CCs) are combined across LTE and NR. Each CC may represent a channel that facilitates communication between the UE and the network over a particular frequency band. A plurality of CCs may correspond to the same frequency band, each CC may correspond to a different band, or a combination of CCs across the same frequency band and different frequency bands may be used.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of an example architecture of a wireless communication system, according to embodiments disclosed herein.

FIG. 2 is a block diagram of an example architecture of a wireless communication system, according to embodiments disclosed herein.

FIG. 3 is a table showing restrictions for cross PUCCH group configurations.

FIG. 4 is a table showing feature groups for cross PUCCH group related capability reporting.

FIG. 5 is a flow diagram of a method, according to one embodiment.

FIG. 6 is a flow diagram of a method, according to another embodiment.

FIG. 7 is a set of tables showing CSI computation delays.

FIG. 8 is a block diagram of a system for performing signaling between a wireless device and a network device, according to embodiments disclosed herein.

### DETAILED DESCRIPTION OF EMBODIMENTS

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

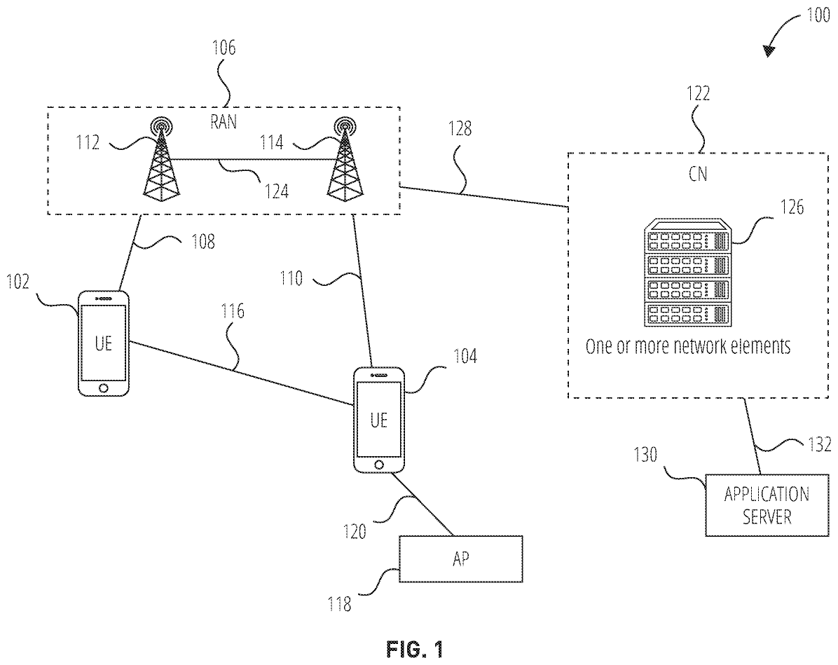

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 122.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 124. In embodiments where the wireless communication system 100 is an LTE system (e.g., when the CN 122 is an EPC), the interface 124 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 122 is a 5GC), the interface 124 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 122).

The RAN 106 is shown to be communicatively coupled to the CN 122. The CN 122 may comprise one or more network elements 126, which are configured to offer various data and telecommunications services to customers/subscribers (e.g., users of UE 102 and UE 104) who are connected to the CN 122 via the RAN 106. The components of the CN 122 may be implemented in one physical device or separate physical devices including components to read and execute instructions from a machine-readable or computer-readable medium (e.g., a non-transitory machine-readable storage medium).

In embodiments, the CN 122 may be an EPC, and the RAN 106 may be connected with the CN 122 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 122 may be a 5GC, and the RAN 106 may be connected with the CN 122 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 122 (e.g., packet switched data services). The application server 130 can also be configured to support one or more communication services (e.g., VoIP sessions, group communication sessions, etc.) for the UE 102 and UE 104 via the CN 122. The application server 130 may communicate with the CN 122 through an IP communications interface 132.

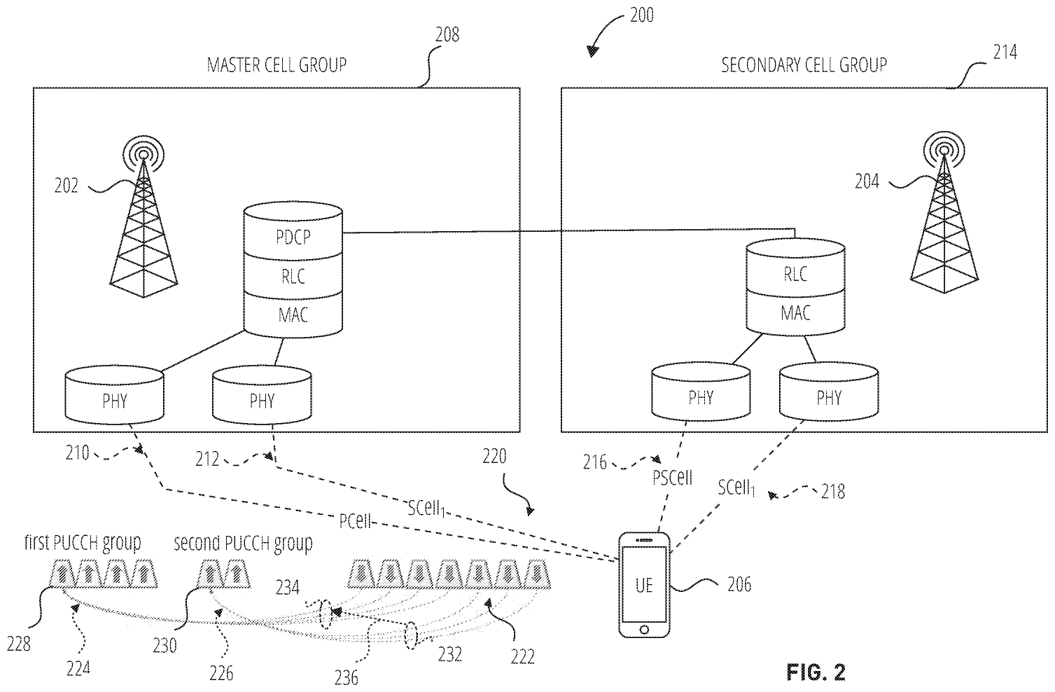

FIG. 2 shows a wireless communication system 200 configured for dual connectivity and carrier aggregation. In FIG. 2, a master RAN 202 is a radio access node that provides the control plane connection to a core network, e.g., for multi radio dual connectivity (MR-DC). A secondary RAN 204 is a radio access node having no control plane connection to the core network, but providing additional resources to a UE 206 in case of MR-DC.

Different types of a master RAN 202 or a secondary RAN 204 provide for different configurations of multi radio dual connectivity (MR-DC). For example, NG-RAN-E-UTRA DC (NGEN-DC) is a configuration using the EPC, whereby master RAN 202 is a 4G ng-eNB and secondary RAN 204 is a 5G gNB. In another example, eNB in E-UTRA-NR DC (EN-DC) is a configuration using the EPC, whereby master RAN 202 is a 4G eNB and secondary RAN 204 is a 5G en-gNB. And in another example, NR-E-UTRA DC (NE-DC) is a configuration using the 5GC, whereby master RAN 202 is a 5G gNB and secondary RAN 204 is a 4G ng-eNB. Finally, NR-DC is a configuration using the 5GC, whereby both the master and secondary RAN nodes are 5G gNBs.

Master RAN 202 provides a master cell group, MCG 208. MCG 208 is a group of serving cells, associated with master RAN 202, including PCell 210 and optionally one or more SCells 212. It can be simply understood that the group where UE 206 initiates random access (RACH) is the master cell group.

Secondary RAN 204 provides a secondary cell group, SCG 214. SCG 214 is a group of serving cells, associated with 212, including SpCell (PSCell 216) and optionally one or more SCells 218.

Carrier aggregation 220 uses physical uplink control channel (PUCCH) grouping to provide uplink control signaling, such as hybrid-ARQ acknowledgments (HARQ-ACK) to inform a gNB about the success or failure of downlink data reception for downlink component carriers 222. With PUCCH grouping, to avoid overloading a single uplink carrier, it is possible to configure two PUCCH groups including a first PUCCH group 224 and a second PUCCH group 226. The specification 3GPP TS 38.331 describes how a PUCCH group is configured. In PDSCH-ServingCellConfig, the network configures which PUCCH cell is used to carry HARQ-ACK feedback for the corresponding downlink serving cell. This is how the PUCCH group is configured, i.e., mapping multiple downlink serving cells to one PUCCH cell to form a PUCCH group. Feedback relating to first PUCCH group 224 of carriers is transmitted in an uplink 228 of PCell 210 and feedback relating to second PUCCH group 226 of carriers are transmitted on an uplink 230 another cell known as a PUCCH-SCell.

FIG. 2 also shows an example of cross PUCCH group CSI reporting 236. For example, cross PUCCH group CSI reporting 236 is when a CSI measurement 232 is performed on downlink cell of one PUCCH group (e.g., second PUCCH group 226), however, a corresponding CSI report 234 is sent on either PUCCH or a physical uplink shared channel (PUSCH) of the other PUCCH group (e.g., first PUCCH group 224). Currently, the 3GPP specification does not clearly address support for cross PUCCH group CSI reporting.

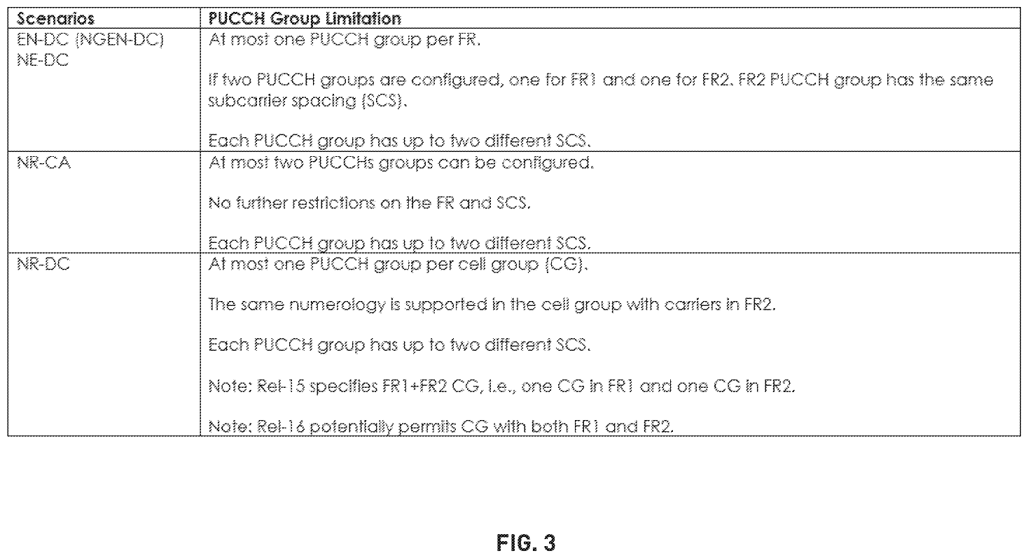

Restrictions on PUCCH group configurations are described in the specification numbers 3GPP TS 38.331 and 38.213. FIG. 3 shows a table summarizing various restrictions are currently specified for PUCCH group configurations, depending on the type of CA or DC functionality deployed. For example, a first row in FIG. 3 shows restrictions for EN-DC, NGEN-DC, and NE-DC. A second row in FIG. 3 shows restrictions for NR-CA. A third row in FIG. 3 shows restriction for NR-DC.

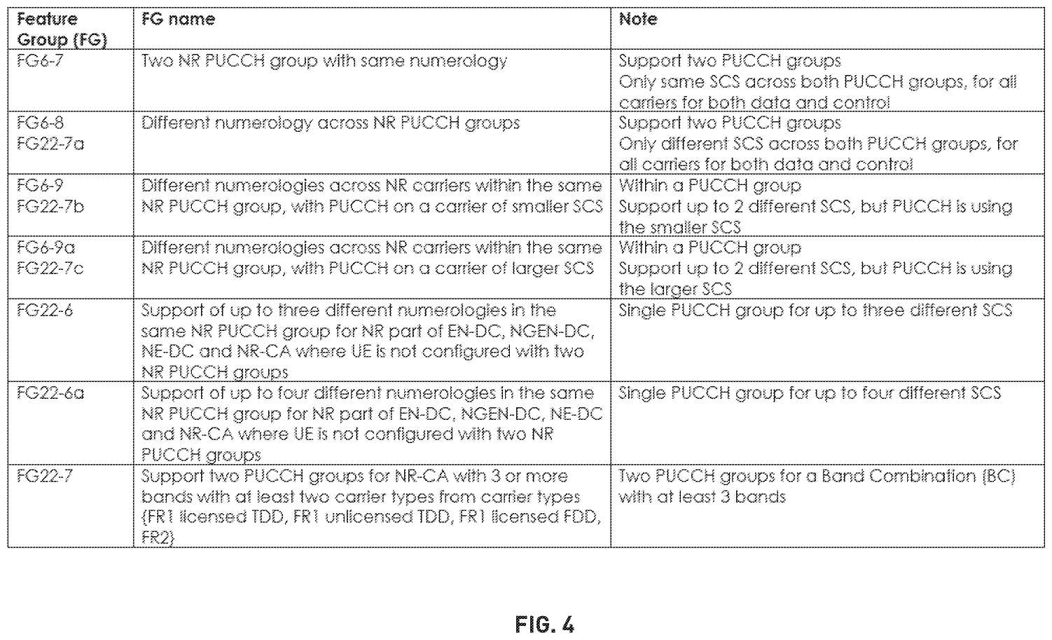

To accommodate the previously described restrictions and band combinations, the PUCCH group related capability reporting includes several feature groups summarized in the table shown in FIG. 4.

In the current NR specification, there is support four types of CSI reporting: (1) periodic CSI reporting on PUCCH; (2) semi-persistent CSI reporting on PUCCH, activated by MAC-CE; (3) semi-persistent CSI reporting on PUSCH triggered by DCI; and (4) aperiodic CSI reporting on PUSCH triggered by DCI. But as noted previously, the 3GPP specification is not clear on whether cross PUCCH group CSI reporting is supported. Accordingly, this disclosure addresses the cross PUCCH group CSI reporting related design to address the UE implementation complexity and timeline concern. Additional details provided below describe (1) UE capability related to cross PUCCH group CSI reporting and (2) CSI timeline relaxation for cross PUCCH group CSI reporting.

UE capability information is provided in an RRC message that a UE sends to the network (e.g., during initial registration process). The message provides details of the capabilities of the UE.

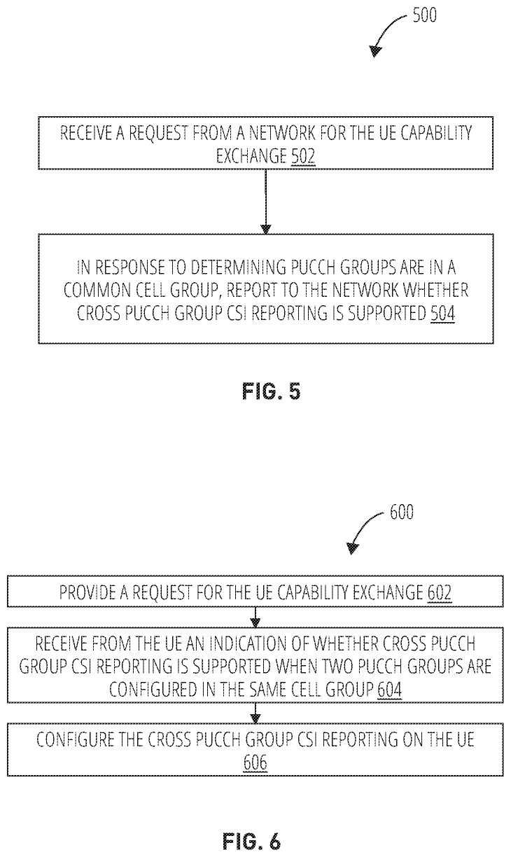

FIG. 5, for example, shows a method 500 of UE capability reporting for cross PUCCH group CSI. In block 502, the UE receives a request from a network for the UE capability exchange. In block 504, the UE reports to the network whether cross PUCCH group CSI reporting is supported when two PUCCH groups are configured in the same cell group (CG).

In some embodiments, support for cross PUCCH group CSI reporting may depend on whether two PUCCH groups are within the same CG or are from different CG. For PUCCH groups from different CGs, cross CG CSI reporting need not be performed. For example, a UE determines that the PUCCH groups are from different CGs and it may then simply ignore a cross PUCCH group CSI reporting configuration. For PUCCH groups in the same CG, cross PUCCH CSI reporting is supported, according to the following embodiments.

In some embodiments, there are several options in connection for network configuration of cross PUCCH group CSI reporting on one or both PUCCH and PUSCH. A first option is that cross PUCCH group CSI reporting cannot be configured by the network, neither for CSI reporting on PUCCH nor for CSI reporting on PUSCH. A second option is that cross PUCCH group CSI reporting can be configured by the network, only for CSI reporting on PUSCH, but not for CSI reporting on PUCCH. A third option is that cross PUCCH group CSI reporting can be configured by the network for both CSI reporting on PUSCH and for CSI reporting on PUCCH.

In other embodiments, there are options for the UE indicating whether it supports cross PUCCH group CSI reporting on one or both PUCCH and PUSCH. For example, the UE may indicate whether it supports the following either jointly or independently: cross PUCCH group CSI reporting on PUCCH and cross PUCCH group CSI reporting on PUSCH.

In some other embodiments, for cross PUCCH group CSI reporting, the UE indicates whether UE supports cross PUCCH group CSI reporting on PUCCH. There are two options. A first option is that support is reported as indication of ability. In this scenario, if the UE does not report the corresponding capability, it is assumed that the UE cannot support cross PUCCH group CSI reporting on PUCCH. Alternatively, a second option is that support is reported as indication of inability. In this scenario, if the UE does not report the corresponding capability, it is assumed that the UE can support cross PUCCH group CSI reporting on PUCCH.

In another embodiment, for cross PUCCH group CSI reporting, the UE indicates whether it supports cross PUCCH group CSI reporting on PUCCH with different granularity of the report. For example, the UE may indicate it reports per BC (band combination), per UE, or per band per BC (called per feature set (FS) when implemented in 3GPP in RAN2). In NR, UE can be configured to operate in Carrier Aggregation (CA) operation. The CA operation can be across multiple bands. All the bands in one CA operation is called band combination (BC). UE can be configured to operate CA in different BC. So in terms of granularity, per UE has the least granularity, per BC has the second least granularity, and FS has most granularity.

In yet another embodiment, for cross PUCCH group CSI reporting, UE can indicate whether UE supports cross PUCCH group CSI reporting on PUCCH in terms of the frequency range (FR). The subcarrier spacing (SCS) in different frequency ranges can be very different, so the processing timelines and sampling frequencies are also different. Accordingly, the UE may indicate whether it supports cross FR CSI reporting, such as, for example, one PUCCH group is configured in FR1 and another PUCCH group is configured in FR2. For instance, measurement of FR1/FR2 downlink cell in one PUCCH group is reported in FR2/FR1 uplink cell of the other PUCCH group on PUCCH.

In still another embodiment, for cross PUCCH group CSI reporting, when the UE indicates it supports cross PUCCH group CSI reporting on PUCCH per FS (per band per band combination), there is an indication of which band is measured and which band carries the report. Thus, the capability report can have the following three options. In a first option, the UE indicates the support of cross PUCCH group CSI reporting on PUCCH in the corresponding band. In other words, there is not restriction on the measurement band, but the CSI report is provided in a particular band indicated in the UE capability report. Conversely, in a second option, the UE indicates the support of cross PUCCH group CSI measurement on downlink in the corresponding band. In other words, the UE indicates a restriction on the measurement band but there is no restriction on the reporting band. In a third option, the UE indicates both the support of cross PUCCH group CSI reporting on PUCCH in the corresponding band and the support of cross PUCCH group CSI measurement on downlink in the corresponding band.

In a further embodiment, for cross PUCCH group CSI reporting, when UE indicates whether UE supports cross PUCCH group CSI reporting on PUCCH per BC (band combination), the capability reporting can be based on carrier types, i.e., FR1 licensed TDD, FR1 unlicensed TDD, FR1 licensed FDD, and FR2. Accordingly, there are three options. A first option is to indicate with a single bit support (or not) for any type. A second option is to indicate support of one or multiple pairs, i.e., carrier type A and carrier type B. This means the UE supports performing CSI measurement on carrier type A and then reporting the measurement results in carrier type B. A third option is to indicate one or multiple bitmaps, e.g., each bitmap is four bits with each bit corresponding to support for one of the four carrier types. The value of each bit can represent where the report is provided (no restriction on measurement), where the measurement is taken (no restriction on reporting), or each bit in the bitmap indicates both the support of cross PUCCH group CSI reporting on PUCCH in the corresponding band and the support of cross PUCCH group CSI measurement on downlink in the corresponding band.

FIG. 6 shows a method 600 for network configuration of cross PUCCH group CSI reporting. In block 602, method 600 entails providing a request for the UE capability exchange. In block 604, method 600 entails receiving from the UE an indication of whether cross PUCCH group CSI reporting is supported when two PUCCH groups are configured in the same cell group. At the time the UE reports its capabilities, the UE need not know whether two PUCCH groups are in the same CG. The UE reports the capability and the network configures the UE accordingly, without exceeding the UE capability. Thus, the network configures the CG and PUCCH group so the UE knows it based on the network configuration. In other words, the UE assumes that the network configures the PUCCH groups in the same CG, and then, the UE reports whether or not it supports such a configuration. In block 606, method 600 entails configuring the cross PUCCH group CSI reporting on the UE.

This disclosure also describes examples of timeline relaxation for accommodating cross PUCCH group CSI reports. For periodic and semi-persistent CSI reporting, the minimum processing time is specified in 3GPP TS 38.214 as follows: if a single CSI-RS/SSB resource is configured for channel measurement, nest ref is the smallest value greater than or equal to 4*2^{μDL}, such that it corresponds to a valid downlink slot; and if multiple CSI-RS/SSB resources are configured for channel measurement, n_{CSI_ref} is the smallest value greater than or equal to 5*2^{μDL}, such that it corresponds to a valid downlink slot.

In some embodiments, when cross PUCCH group CSI reporting is supported and configured, for periodic and semi-persistent CSI reporting, additional processing timeline relaxation is provided. A first option is that the relaxation is statically predetermined in accordance with a 3GPP specification. A second option is that the relaxation can be reported by the UE as a capability. For example, the relaxation can be reported/hardcoded per SCS. The SCS can be the SCS of the downlink for measurement, the SCS of the uplink for reporting, or a minimum SCS of the downlink for measurement and the uplink for reporting.

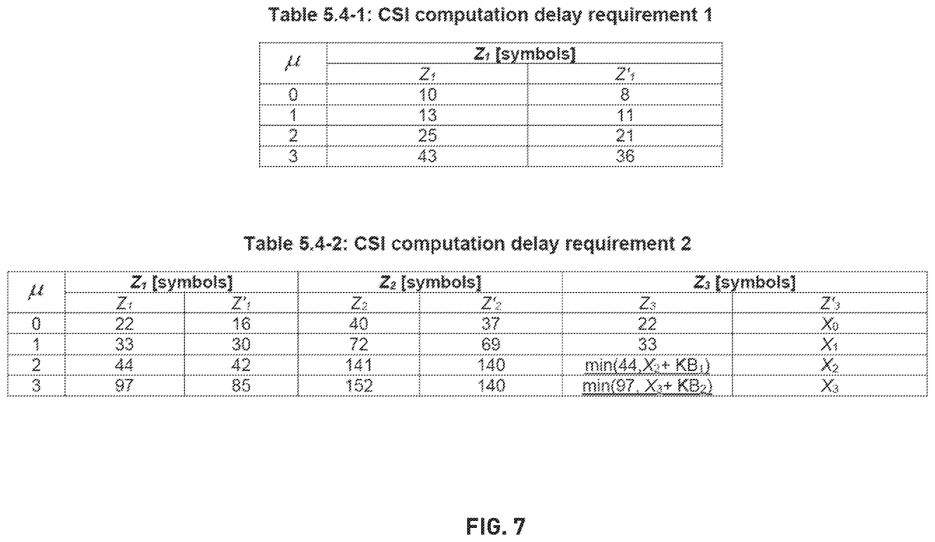

For aperiodic CSI processing, the minimum processing timeline is specified as Z and Z′ in 3GPP TS 38.818. Z is the time offset between the end of PDCCH that triggers AP-CSI and the beginning of PUSCH that carries AP-CSI. Z′ is the time offset between the end of reference signals and the beginning of PUSCH that carries AP-CSI. There are four types of Z and Z′: one for low latency CSI processing, see e.g., Table 5.4-1 (reproduced in FIG. 7); and three for regular CSI processing, see e.g., Table 5.4-2 (reproduced in FIG. 7). The Table 5.4-2 includes Z₁, Z₂, and Z₃. Z₁ is for low complexity CSI reporting without low latency. Z₂ is for medium high complexity CSI reporting without low latency. Z₃ is for the FR2 beam management reporting.

In some embodiments, when cross PUCCH group CSI reporting is supported and configured, the low latency CSI reporting (i.e., Table 5.4-1) is not supported for aperiodic CSI reporting. In other embodiments, when cross PUCCH group CSI reporting is supported and configured, additional processing timeline relaxation is provided for aperiodic CSI reporting. For example, the relaxation is statically predetermined in accordance with a 3GPP specification. In another example, the relaxation can be reported by the UE as a capability (e.g., for different Z₁, Z₂, or Z₃ shown in FIG. 7). The relaxation can be reported/hardcoded per SCS, in which the SCS is the minimum SCS among the SCS used for the DCI that triggers the AP-CSI reporting, the SCS(s) used for the CSI-RS(s) for CSI measurement, and the SCS used for PUSCH with which the SCS report is to be transmitted. AP CSI triggering and reporting involves multiple steps, and each step may be configured with different SCS.

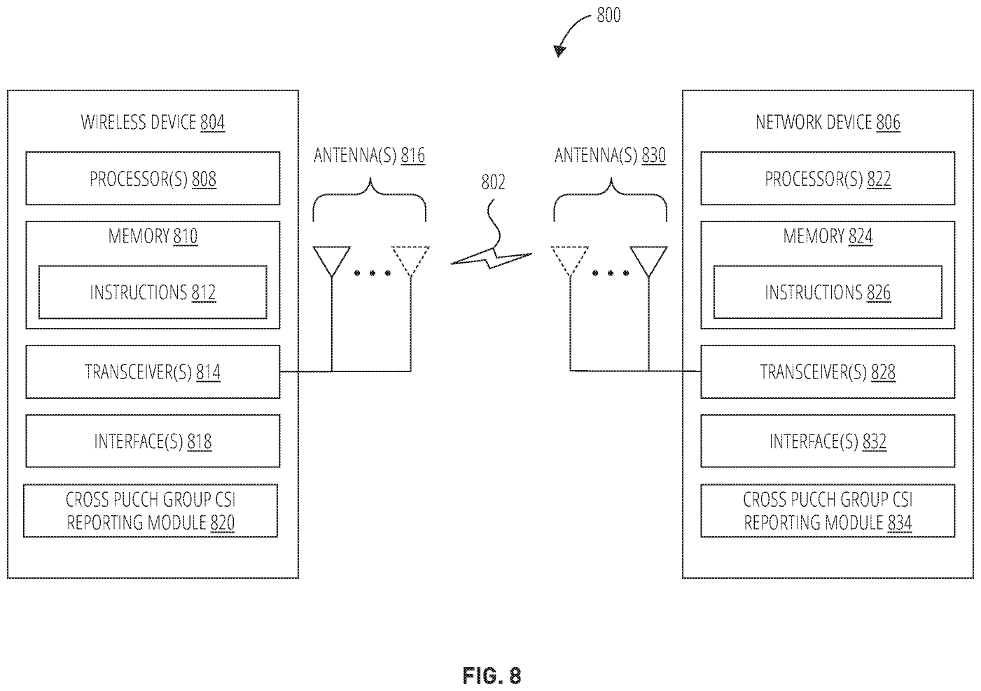

FIG. 8 illustrates a system 800 for performing signaling 802 between a wireless device 804 and a network device 806, according to embodiments disclosed herein. System 800 may be a portion of a wireless communications system as herein described. Wireless device 804 may be, for example, a UE of a wireless communication system. Network device 806 may be, for example, a base station (e.g., an eNB or a gNB) of a wireless communication system.

Wireless device 804 may include one or more processor(s) 808. Processor(s) 808 may execute instructions such that various operations of wireless device 804 are performed, as described herein. Processor(s) 808 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

Wireless device 804 may include a memory 810. Memory 810 may be a non-transitory computer-readable storage medium that stores instructions 812 (which may include, for example, the instructions being executed by processor(s) 808). Instructions 812 may also be referred to as program code or a computer program. Memory 810 may also store data used by, and results computed by, processor(s) 808.

Wireless device 804 may include one or more transceiver(s) 814 that may include radio frequency (RF) transmitter and/or receiver circuitry that use antenna(s) 816 of wireless device 804 to facilitate signaling (e.g., signaling 802) to and/or from wireless device 804 with other devices (e.g., network device 806) according to corresponding RATs.

Wireless device 804 may include one or more antenna(s) 816 (e.g., one, two, four, or more). For embodiments with multiple antenna(s) 816, wireless device 804 may leverage the spatial diversity of such multiple antenna(s) 816 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by wireless device 804 may be accomplished according to precoding (or digital beamforming) that is applied at wireless device 804 that multiplexes the data streams across antenna(s) 816 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, wireless device 804 may implement analog beamforming techniques, whereby phases of the signals sent by antenna(s) 816 are relatively adjusted such that the (joint) transmission of antenna(s) 816 can be directed (this is sometimes referred to as beam steering).

Wireless device 804 may include one or more interface(s) 818. Interface(s) 818 may be used to provide input to or output from wireless device 804. For example, a wireless device 804 that is a UE may include interface(s) 818 such as microphones, speakers, a touchscreen, buttons, and the like in order to allow for input and/or output to the UE by a user of the UE. Other interfaces of such a UE may be made up of made up of transmitters, receivers, and other circuitry (e.g., other than transceiver(s) 814/antenna(s) 816 already described) that allow for communication between the UE and other devices and may operate according to known protocols (e.g., Wi-Fi®, Bluetooth®, and the like).

Wireless device 804 may include a cross PUCCH group CSI reporting module 820. Cross PUCCH group CSI reporting module 820 may be implemented via hardware, software, or combinations thereof. For example, cross PUCCH group CSI reporting module 820 may be implemented as a processor, circuit, and/or instructions 812 stored in memory 810 and executed by processor(s) 808. In some examples, cross PUCCH group CSI reporting module 820 may be integrated within processor(s) 808 and/or transceiver(s) 814. For example, cross PUCCH group CSI reporting module 820 may be implemented by a combination of software components (e.g., executed by a DSP or a general processor) and hardware components (e.g., logic gates and circuitry) within processor(s) 808 or transceiver(s) 814.

Cross PUCCH group CSI reporting module 820 may be used for various aspects of the present disclosure, for example, aspects of FIG. 2 and FIG. 5. In some embodiments, cross PUCCH group CSI reporting module 820 is configured to facilitate the capability exchange. Embodiments contemplated herein include an apparatus comprising means to perform one or more elements of method 500 (FIG. 5). This apparatus may be, for example, an apparatus of a UE (such as a wireless device 804 that is a UE, as described herein).

Embodiments contemplated herein include one or more non-transitory computer-readable media comprising instructions to cause an electronic device, upon execution of the instructions by one or more processors of the electronic device, to perform one or more elements of method 500. This non-transitory computer-readable media may be, for example, a memory of a UE (such as a memory 810 of a wireless device 804 that is a UE, as described herein).

Embodiments contemplated herein include an apparatus comprising logic, modules, or circuitry to perform one or more elements of method 500. This apparatus may be, for example, an apparatus of a UE (such as a wireless device 804 that is a UE, as described herein).

Embodiments contemplated herein include an apparatus comprising: one or more processors and one or more computer-readable media comprising instructions that, when executed by the one or more processors, cause the one or more processors to perform one or more elements of method 500. This apparatus may be, for example, an apparatus of a UE (such as a wireless device 804 that is a UE, as described herein).

Embodiments contemplated herein include a signal as described in or related to one or more elements of method 500.

Embodiments contemplated herein include a computer program or computer program product comprising instructions, wherein execution of the program by a processor is to cause the processor to carry out one or more elements of method 500. The processor may be a processor of a UE (such as a processor(s) 808 of a wireless device 804 that is a UE, as described herein). These instructions may be, for example, located in the processor and/or on a memory of the UE (such as a memory 810 of a wireless device 804 that is a UE, as described herein).

Network device 806 may include one or more processor(s) 822. processor(s) 822 may execute instructions such that various operations of network device 806 are performed, as described herein. Processor(s) 822 may include one or more baseband processors implemented using, for example, a CPU, a DSP, an ASIC, a controller, an FPGA device, another hardware device, a firmware device, or any combination thereof configured to perform the operations described herein.

Network device 806 may include a memory 824. Memory 824 may be a non-transitory computer-readable storage medium that stores instructions 826 (which may include, for example, the instructions being executed by processor(s) 822). Instructions 826 may also be referred to as program code or a computer program. Memory 824 may also store data used by, and results computed by, processor(s) 822.

Network device 806 may include one or more transceiver(s) 828 that may include RF transmitter and/or receiver circuitry that use antenna(s) 830 of network device 806 to facilitate signaling (e.g., signaling 802) to and/or from network device 806 with other devices (e.g., wireless device 804) according to corresponding RATs.

Network device 806 may include one or more antenna(s) 830 (e.g., one, two, four, or more). In embodiments having multiple antenna(s) 830, network device 806 may perform MIMO, digital beamforming, analog beamforming, beam steering, etc., as has been described.

Network device 806 may include one or more interface(s) 832. Interface(s) 832 may be used to provide input to or output from network device 806. For example, a network device 806 that is a base station may include interface(s) 832 made up of transmitters, receivers, and other circuitry (e.g., other than transceiver(s) 828/antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

Network device 806 may include a cross PUCCH group CSI reporting module 834. Cross PUCCH group CSI reporting module 834 may be implemented via hardware, software, or combinations thereof. For example, cross PUCCH group CSI reporting module 834 may be implemented as a processor, circuit, and/or instructions 826 stored in memory 824 and executed by processor(s) 822. In some examples, cross PUCCH group CSI reporting module 834 may be integrated within processor(s) 822 and/or the transceiver(s) 828. For example, cross PUCCH group CSI reporting module 834 may be implemented by a combination of software components (e.g., executed by a DSP or a general processor) and hardware components (e.g., logic gates and circuitry) within processor(s) 822 or transceiver(s) 828.

Cross PUCCH group CSI reporting module 834 may be used for various aspects of the present disclosure, for example, aspects of FIG. 2 and FIG. 6. Cross PUCCH group CSI reporting module 834 is configured to facilitate capability exchange and configuration of cross PUCCH group CSI reporting by the network.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of user equipment (UE) capability exchange for indicating support of cross physical uplink control channel (PUCCH) group channel state information (CSI) reporting, the method comprising:
receiving a request from a network for the UE capability exchange; and
reporting to the network whether cross PUCCH group CSI reporting is supported when two PUCCH groups are configured in the same cell group.

2. The method of claim 1, further comprising:
measuring CSI associated with a first PUCCH group; and
reporting the CSI in an uplink of a second PUCCH group.

3. The method of claim 1, in which the reporting to the network comprises indicating whether the UE supports cross PUCCH group CSI reporting on a PUCCH.

4. The method of claim 1, in which the reporting to the network comprises indicating whether the UE supports cross PUCCH group CSI reporting on a physical uplink shared channel (PUSCH).

5. The method of claim 1, in which the reporting to the network comprises indicating whether the UE supports cross PUCCH group CSI reporting per UE.

6. The method of claim 1, in which the reporting to the network comprises indicating whether the UE supports cross PUCCH group CSI reporting per band combination.

7. The method of claim 1, in which the reporting to the network comprises indicating whether the UE supports cross PUCCH group CSI reporting per feature set (FS).

8. The method of claim 1, in which the reporting to the network comprises indicating whether the UE supports cross PUCCH group CSI reporting based on carrier types, the carrier types including FR1 licensed time division duplex (TDD), FR1 unlicensed TDD, FR1 frequency division duplex (FDD), and FR2.

9. The method of claim 8, in which the indicating comprises indicating one or multiple pairs of carrier types, in which a first carrier type of the pair represents support for a measurement on the first carrier type, and a second carrier type of the pair represents support for a report in the second carrier type.

10. The method of claim 1, in which the reporting to the network comprises indicating whether the UE supports cross PUCCH group CSI reporting for a first PUCCH group configured for FR1 and a second PUCCH group configured for FR2.

11. The method of claim 10, in which a measurement of an FR1 downlink cell in the first PUCCH group is reported in an FR2 uplink cell of the second PUCCH group.

12. The method of claim 10, in which a measurement of an FR2 downlink cell in the second PUCCH group is reported in an FR1 uplink cell of the first PUCCH group.

13. The method of claim 1, in which, for periodic or semi-persistent CSI reporting, the reporting to the network comprises indicating additional processing time is required by the UE for measurement and reporting.

14. The method of claim 1, in which, for aperiodic CSI reporting, the reporting to the network comprises indicating additional processing time is required by the UE for Downlink Control Information (DCI) processing, measurement, and reporting.

15. A non-transitory computer-readable storage medium of a user equipment (UE), the computer-readable storage medium including instructions for capability exchange for indicating support of cross physical uplink control channel (PUCCH) group channel state information (CSI) reporting, the instructions, when executed by the UE, cause the UE to:
receive a request from a network for the capability exchange; and
report to the network whether cross PUCCH group CSI reporting is supported when two PUCCH groups are configured in the same cell group.

16. The computer-readable storage medium of claim 15, wherein the instructions further configure the UE to:
measure CSI associated with a first PUCCH group; and
report the CSI in an uplink of a second PUCCH group.

17. The computer-readable storage medium of claim 15, in which the report to the network indicates whether the UE supports cross PUCCH group CSI reporting on a PUCCH.

18. The computer-readable storage medium of claim 15, in which the report to the network indicates whether the UE supports cross PUCCH group CSI reporting on a physical uplink shared channel (PUSCH).

19. The computer-readable storage medium of claim 15, in which the report to the network indicates whether the UE supports cross PUCCH group CSI reporting per UE.

20. The computer-readable storage medium of claim 15, in which the report to the network indicates whether the UE supports cross PUCCH group CSI reporting per band combination.

21-29. (canceled)
